(19) United States
(12) Patent Application Publication
(10) Pub. No.: US 2026/0012059 A1
(43) Pub. Date: Jan. 8, 2026

(54) ELECTRIC MACHINE HAVING A PASSIVE VALVE

(71) Applicants: MAGNA Powertrain GmbH & Co KG, Lannach (AT); Joma-Polytec GmbH, Bodelshausen (DE)

(72) Inventors: Stefan Lienhart, Graz (AT); Christoph Gsenger, Graz (AT); Michael Dienbauer, Graz (AT); Wolfgang Schweiger, St. Stefan (AT); Matthias Hluchy, Bodelshausen (DE); Stefan Heinz, Bodelshausen (DE); Isabelle Kümmerle, Bodelshausen (DE)

(21) Appl. No.: 18/993,745

(22) PCT Filed: Jul. 10, 2023
(86) PCT No.: PCT/EP2023/068958

§ 371 Date: Jan. 13, 2025

(30) Foreign Application Priority Data
Jul. 14, 2022 (DE) 10 2022 207 221.9

(51) Int. Cl. H02K 7/00; F16K 25/00; F16K 31/00; H02K 1/32

(52) U.S. Cl. CPC H02K 7/003; F16K 25/005; F16K 31/002; H02K 1/32; F16K 2200/302; F16K 2200/305; H02K 2213/09

(57) ABSTRACT

An electric machine includes a rotor shaft having a first axial bore. A passive valve for temperature-dependent flow control of the coolant is arranged in the first axial bore. The passive valve has a valve body, a valve piston axially movable within the valve body, and a valve cap fixed to the valve piston. A first valve spring biases the valve piston and the valve cap toward a closed position of the passive valve and is arranged between the valve body and the valve piston. A second valve spring formed from a shape memory alloy is arranged between the valve body and the valve cap and expands when a limit temperature is exceeded and forces the valve cap and the valve piston into an open position of the passive valve.

### CROSS-REFERENCE TO RELATED APPLICATIONS

This application is a National Stage of International Application No. PCT/EP2023/068958, filed on Jul. 10, 2023, which claims priority to DE 10 2022 207 221.9, filed on Jul. 14, 2022. The entire disclosures of each of the above applications are incorporated herein by reference.

### FIELD

The present disclosure relates to an electric machine including a rotor fastened on a shaft, wherein the shaft has a first axial bore, wherein a passive valve which releases the flow of a coolant to the rotor as a function of a limit temperature, i.e. in a temperature-dependent fashion, is arranged in the first axial bore of the shaft.

### BACKGROUND

Electric machines of the abovementioned type serve to convert energy from electrical to mechanical energy, and vice versa, and are widely used as motors and/or generators in the automotive engineering sector.

Electric machines include a stationary stator and a movable rotor, wherein the rotor is, in the most common structural form of an electric machine, rotatably mounted inside a stator with an annular form.

Because of the dielectric loss during their operation, electric machines generate heat which, on the one hand, causes diminished efficiency of the electric machine and, on the other hand, negatively influences reliable operation of the electric machine over its lifetime. A cooling device which cools the parts of the electric machine which need to be cooled is therefore generally provided in drive assemblies.

Conventional cooling systems for electric machines make use of a circulating gaseous or liquid coolant. The coolant circulates, for example, in a housing of the electric machine or in a rotor shaft, configured as a hollow shaft, on which the rotor of the electric machine is arranged. Because of its heat capacity, the coolant absorbs the heat and removes it.

### SUMMARY

The object of the present disclosure is to provide an electric machine which includes load-point-dependent cooling of a rotor.

This object is achieved by the subject matter of the present disclosure.

Advantageous embodiments of the present disclosure are described herein.

The electric machine includes according to the present disclosure a stator, a rotor mounted about a central axis of rotation, a shaft on which the rotor is fastened and which has a first axial bore, and an inflow element.

According to the present disclosure, a passive valve which releases a stream of coolant into the shaft as a function of the shaft temperature is arranged in the first axial bore of the shaft.

The passive valve has according to the present disclosure a valve body, a valve piston which is axially displaceable inside the valve body and has a second axial bore, and an axially displaceable valve cap which is fixedly connected to the valve piston.

The directional specification “axially” describes in this context a direction along or parallel to the central axis of rotation of the rotor.

The directional specification “radially” describes in this context a direction perpendicular to the central axis of rotation of the rotor.

The inflow element extends into the second axial bore in such a way that a coolant can flow from the inflow element into the second axial bore.

According to the present disclosure, a first valve spring forcing the valve piston and hence the valve cap into a first position, namely a closed position of the passive valve, is arranged between the valve body and the valve piston.

Furthermore, according to the present disclosure, a second valve spring which is made from a shape memory alloy is arranged between the valve body and the sealing cap. A shape memory alloy is understood to be a special metal alloy which can be present in two different crystal structures depending on the temperature. The change of form is based on a temperature-dependent lattice transformation. The structural transformation is here not dependent on the speed of the change in temperature.

Forming the second valve spring from a shape memory alloy means that the second valve spring experiences a change in length, namely travel, when a limit temperature is exceeded and thus forces the valve cap and hence the valve piston into a second position, namely an open position of the passive valve.

The second valve spring is thus an actuator for activating the passive valve.

In one embodiment of the present disclosure, the passive valve has a bypass duct through which coolant can flow and which fluidically connects a chamber to the second axial bore, wherein the second valve spring is arranged in the chamber. This chamber separates the heat-sensitive second valve spring from the main stream of coolant. The chamber filled with the coolant (for example, oil) ensures the constant and uniform transporting of heat from the shaft to the heat-sensitive second valve spring, over all the operating points of the electric machine.

The valve piston has, in one embodiment of the present disclosure, at least one radial bore via which the second axial bore can be fluidically connected to the surroundings of the shaft, wherein the valve body includes a sealing region on which the radial bore comes to bear in the open position of the passive valve and the axial bore is thus sealed with respect to the surroundings of the shaft.

The valve body furthermore preferably includes a valve seat and a sealing region, wherein a sealing region of the valve cap comes to bear on the valve seat in the closed position of the passive valve.

The passive valve is preferably arranged in the region of a shaft input of the shaft, preferably in a region of the shaft input of the shaft at which an output gear is formed on an outer circumference of the shaft.

The valve body is preferably formed from a material which has a coefficient of thermal conductivity which is lower than the coefficient of thermal conductivity of a fluid present in the chamber.

The valve body can be manufactured from a polymer material, namely for example a plastic.

### BRIEF DESCRIPTION OF THE DRAWINGS

The present disclosure is described below by way of example with reference to the drawings.

FIG. 1 shows a detailed view of a shaft with a passive valve in a closed position.

FIG. 2 shows a detailed view of a shaft with a passive valve in an open position.

### DETAILED DESCRIPTION

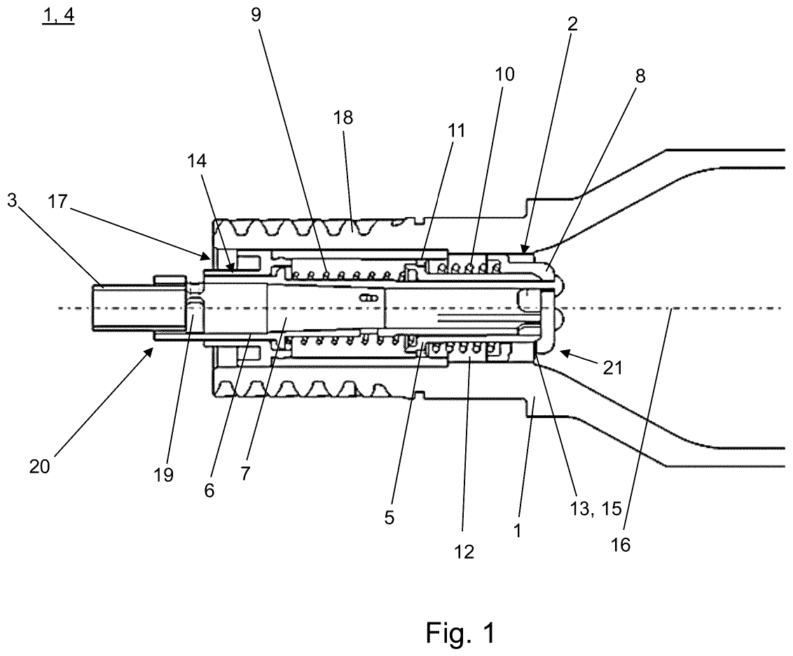

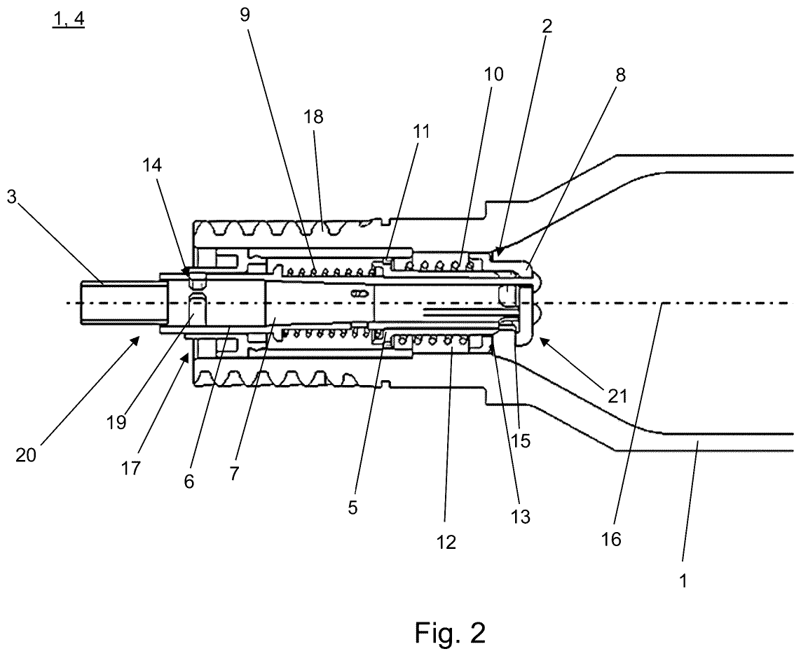

FIG. 1 and FIG. 2 show in each case a detailed view of a shaft 1 of an electric machine according to the present disclosure.

The electric machine includes a stator and a rotor. The stator is fastened in a housing and the rotor is mounted inside the stator so that it can rotate about a central axis of rotation 16. The rotor is fastened on the shaft 1 so that it is fixed in rotation and axially fixed.

The shaft 1 has a first axial bore 2. A passive valve 4 for the temperature-dependent control of a stream of coolant is arranged in the first axial bore 2 of the shaft 1.

The directional specification “axially” describes in this context a direction along or parallel to the central axis of rotation 16 of the rotor.

The directional specification “radially” describes in this context a direction perpendicular to the central axis of rotation 16 of the rotor.

The passive valve 4 is arranged in the region of a shaft input 17 of the shaft 1, namely in a region of the shaft input 17 of the shaft 1 at which an output gear 18 is formed on an outer circumference of the shaft 1.

The passive valve 4 has a valve body 5, a valve piston 6 which is axially displaceable inside the valve body 5 and an axially displaceable valve cap 8 which is fixedly connected to the valve piston 6.

The valve body 5 is produced from a material which is a poor conductor of heat.

The valve piston 6 has a second axial bore 7 and a plurality of radial bores 19 in the region of a first end 20 of the valve piston 6. The radial bores 19 fluidically connect the second axial bore 7 to the surroundings of the shaft 1. The valve cap 8 is arranged in the region of a second end 21 of the valve piston 6.

An inflow element 3 of the electric machine extends in the region of the first end 20 of the valve piston 6 into the second axial bore 7 in such a way that the coolant can flow from the inflow element 3 into the second axial bore 7.

A first valve spring 9 is arranged between the valve body 5 and the valve piston 6. The first valve spring 9 forces the valve piston 6 and hence the valve cap 8 counter to the spring force of the second valve spring 10 into a first position, namely a closed position of the passive valve 4. The first valve spring 9 thus acts as a closing spring.

A second valve spring 10 is arranged between the valve body 5 and the sealing cap 8. The second valve spring 10 is made from a shape memory alloy (SMA) and formed in such a way that it expands when a limit temperature is exceeded and forces the valve cap and hence the valve piston into a second position, namely an open position of the passive valve. The heat-sensitive second valve spring 10 is a helical compression spring via which consequently the desired temperature-dependent change in length and subsequently the required travel at the valve piston 6 can be achieved.

The first valve spring 9 has a spring force which is greater than the spring force of the second valve spring 10 as long as the latter has a temperature below the limit temperature. In this respect, the passive valve 4 is situated in a closed position (FIG. 1) in the case of a temperature below the limit temperature. If the limit temperature is reached or exceeded, the second valve spring 10 experiences a change in length in the axial direction (it expands). The spring force of the second valve spring 10 is chosen such that under these operating conditions it exceeds the spring force of the first valve spring 9. In this respect, the passive valve 4 is situated in an open position (FIG. 2) when the limit temperature is exceeded.

The second valve spring 10 is arranged in a chamber 12 formed by the components the “shaft 1”, the “valve body 5”, and the “valve cap 8”. The chamber 12 is fluidically connected to the second axial bore 7 in the valve piston 6 via a bypass duct 11. The chamber 12 is filled with coolant via bores arranged in the bypass duct 11, i.e. parallel to the main flow path constituted by the second axial bore 7. A limited continuous exchange of fluid between the chamber 12 and the cooling system takes place via defined leakage paths. The circulation of the volume of coolant situated in the chamber 12 thus effected ensures reliable bidirectional functioning of the passive valve 4.

The valve body 5 has a valve seat 13 on which a sealing region 15 of the valve cap 8 comes to bear in the closed position of the passive valve 4, as a result of which the second axial bore 7 of the valve piston 6 is sealed with respect to the first axial bore 2 of the shaft 1 (FIG. 1). In the open position of the passive valve 4, the sealing region 15 of the valve cap 8 lifts off the valve seat 13 and the flow of coolant from the second axial bore 7 to the first axial bore 2 is released (FIG. 2).

The valve body 5 furthermore has a sealing region 14 which, in the open position of the passive valve 4, seals the radial bores 19 in the region of the first end 20 of the valve piston 6 with respect to the surroundings of the shaft 1 and releases the flow of coolant through the second axial bore 7 to the first axial bore 2 (FIG. 2). In the closed position of the passive valve 4, the radial bores 19 of the valve piston 6 do not come to bear on the sealing region 14 of the valve body 5 and instead the coolant path from the second axial bore 7 to the surroundings of the shaft 1, via the radial bores 19, is released (FIG. 1). In this way, an additional proportional directional control valve function can be constituted by the radial bores 19 formed at the first end 20 of the valve piston 6. As a result, additional cooling or lubrication points in the surroundings of the shaft 1 can be supplied with coolant, and for example the cooling of rolling bearings and gears, such as the output gear 18, of the shaft 1 can thus be controlled in a temperature-dependent fashion. Furthermore, a possible dynamic pressure can be built up by this additional cooling path and compressive forces acting in the closed position of the passive valve 4 can be avoided.

### LIST OF REFERENCE SIGNS

1 shaft
2 first axial bore
3 inflow element
4 passive valve
5 valve body
6 valve piston
7 second axial bore
8 valve cap
9 first valve spring
10 second valve spring
11 bypass duct
12 chamber
13 valve seat
14 sealing region of the valve body
15 sealing region of the valve cap
16 central axis of rotation
17 shaft input
18 output gear
19 radial bore
20 first end (of the valve piston)
21 second end (of the valve piston)

What is claimed is:

1. An electric machine comprising
a stator,
a rotor mounted so that it can rotate about a central axis of rotation,
a shaft on which the rotor is fastened and which has a first axial bore,
a passive valve is arranged in the first axial bore of the shaft for the purpose of temperature-dependent flow regulation of coolant,
wherein the passive valve has a valve body, a valve piston which is axially displaceable and axially extends inside the valve body and which has a second axial bore, and a valve cap which is fixedly connected to the valve piston and axially displaceable therewith,
an inflow element which extends into the second axial bore in such a way that a coolant can flow from the inflow element into the second axial bore,
wherein a first valve spring provides a biasing force on the valve piston and the valve cap fixed thereto toward a first position, wherein the first position is a closed position of the passive valve,
wherein the first valve spring is arranged between the valve body and the valve piston and
wherein a second valve spring is arranged between the valve body and the valve cap
wherein the second valve spring is made from a shape memory alloy and is formed such that the second valve spring expands when a limit temperature is exceeded and the second valve spring forces the valve cap and the valve piston fixed thereto into a second position, wherein the second position is an open position of the passive valve.

2. The electric machine as claimed in claim 1, wherein the passive valve has a bypass duct which fluidically connects a chamber to the second axial bore, wherein the second valve spring is arranged in the chamber.

3. The electric machine as claimed in claim 1, wherein the valve piston has at least one radial bore via which the second axial bore is fluidically connected to the surroundings of the shaft when the passive valve is closed, wherein the valve body includes a sealing region on which the radial bore comes to bear in the open position of the passive valve.

4. The electric machine as claimed in claim 3, wherein the valve body includes a valve seat on which a sealing region of the valve cap comes to bear in the closed position of the passive valve.

5. The electric machine as claimed in claim 1, wherein the passive valve is arranged in the region of a shaft input of the shaft.

6. The electric machine as claimed in claim 5, wherein an output gear is formed on the outer circumference of the shaft in the region of the shaft input of the shaft.

7. The electric machine as claimed in claim 2, wherein the valve body is formed from a material which has a coefficient of thermal conductivity which is lower than the coefficient of thermal conductivity of a fluid present in the chamber.

8. The electric machine as claimed in claim 7, wherein the valve body is manufactured from a polymer material.

9. The electric machine as claimed in claim 1, wherein the valve body is fixed relative to the shaft, wherein the valve piston and valve cap fixed thereto are axially moveable relative to the valve body.

10. The electric machine as claimed in claim 4, wherein the valve cap is spaced from the valve seat when the passive valve is in the open position.

11. The electric machine as claimed in claim 1, wherein in the open position, coolant flows into the second axial bore and past the end cap and into the first axial bore of the shaft, wherein in the closed position, the end cap bears against the valve body and blocks coolant from the first axial bore, and coolant flows out of the second axial bore and to a surrounding area of the shaft.

12. The electric machine as claimed in claim 1, wherein an axially biasing force of the first valve spring is greater than an axially biasing force of the second valve spring when the temperature of the second valve spring is below the limit temperature, such that the passive valve is closed.

13. The electric machine as claimed in claim 12, wherein an axially biasing force of the first valve spring is less than an axially biasing force of the second valve spring when the temperature of the second valve spring exceeds the limit temperature, such that the passive valve is open.

14. The electric machine as claimed in claim 2, wherein the chamber is defined radially between the shaft and the valve body, and axially between the bypass duct and the valve cap.

15. The electric machine as claimed in claim 14, wherein the bypass duct includes a plurality of axially extending bores that fluidically limits the flow of coolant between the second axial bore and the chamber.

16. The electric machine as claimed in claim 3, wherein the radial bore axially overlaps the sealing region of the valve body in the open position.

17. The electric machine as claimed in claim 4, wherein the sealing region of the valve cap radially overlaps the valve seat and contacts the valve seat in the closed position.

18. The electric machine as claimed in claim 17, wherein the radial bore is axially offset from the sealing region of the valve body in the closed position, wherein the radial bore axially overlaps the sealing region of the valve body in the open position.
